(19) United States
(12) Patent Application Publication
(10) Pub. No.: US 2024/0353894 A1
(43) Pub. Date: Oct. 24, 2024

(54) ADJUSTABLE CUSHIONS FOR A HEAD-MOUNTED DISPLAY

(71) Applicant: Sony Interactive Entertainment LLC, San Mateo, CA (US)

(72) Inventor: Sean P. Whitcomb, Issaquah, WA (US)

(21) Appl. No.: 18/138,033

(22) Filed: Apr. 21, 2023

(51) Int. Cl. G06F 1/16

(52) U.S. Cl. CPC G06F 1/163

(57) ABSTRACT

An apparatus includes one or more displays, a housing to which the one or more displays are mounted, at least two adjustable cushions attached to the housing and configured to make contact with a user's head when the housing is worn on the head of the user, and a cushion adjustment system configured to adjust a size of each of the at least two adjustable cushions to achieve a desired fit of the housing on the head of the user. A method includes detecting an event indicating that one or more adjustable cushions attached to an interior of a head-mounted display (HMD) should be adjusted in size, determining a size to which each of the one or more adjustable cushions should be adjusted, and automatically adjusting the one or more adjustable cushions to the size determined for each of the one or more adjustable cushions.

### BACKGROUND OF THE INVENTION

### Field of the Invention

Embodiments of the present invention relate generally to display devices, and more specifically to head-mounted displays (HMDs).

### Discussion of the Related Art

A head-mounted display (HMD) is a display device worn on the head of the user. Some HMDs include a display unit having one or more displays positioned in front of the eyes of the user. The display unit is typically supported by a mount that mounts to the head of the user.

HMDs are often used with virtual reality (VR), augmented reality (AR), and mixed reality (MR) systems. An HMD used for VR is sometimes referred to as a VR headset.

### SUMMARY OF THE INVENTION

One embodiment provides an apparatus, comprising: one or more displays; a housing to which the one or more displays are mounted, wherein the housing is configured to be worn on the head of a user in a manner that allows the user's eyes to see images displayed on the one or more displays; at least two adjustable cushions attached to the housing and configured to make contact with the user's head when the housing is worn on the head of the user; and a cushion adjustment system configured to adjust a size of each of the at least two adjustable cushions to achieve a desired fit of the housing on the head of the user.

Another embodiment provides a method, comprising: detecting an event indicating that one or more adjustable cushions attached to an interior of a head-mounted display (HMD) should be adjusted in size, wherein the HMD includes at least two adjustable cushions configured to make contact with a user's head when the HMD is worn on the user's head; in response to the detecting an event, determining a size to which each of the one or more adjustable cushions should be adjusted; and automatically adjusting the one or more adjustable cushions to the size determined for each of the one or more adjustable cushions.

Another embodiment provides a non-transitory computer readable storage medium storing one or more computer programs configured to cause a processor-based system to execute steps comprising: detecting an event indicating that one or more adjustable cushions attached to an interior of a head-mounted display (HMD) should be adjusted in size, wherein the HMD includes at least two adjustable cushions configured to make contact with a user's head when the HMD is worn on the user's head; in response to the detecting an event, determining a size to which each of the one or more adjustable cushions should be adjusted; and automatically adjusting the one or more adjustable cushions to the size determined for each of the one or more adjustable cushions.

Another embodiment provides a system, comprising: a head-mounted display (HMD) that includes at least two adjustable cushions attached to an interior of the HMD that are configured to make contact with a user's head when the HMD is worn on the user's head; and a processor-based system configured to execute steps comprising, detecting an event indicating that one or more of the at least two adjustable cushions should be adjusted in size; in response to the detecting an event, determining a size to which each of the one or more of the at least two adjustable cushions should be adjusted; and automatically adjusting the one or more of the at least two adjustable cushions to the size determined for each of the one or more of the at least two adjustable cushions.

A better understanding of the features and advantages of various embodiments of the present invention will be obtained by reference to the following detailed description and accompanying drawings which set forth an illustrative embodiment in which principles of embodiments of the invention are utilized.

### BRIEF DESCRIPTION OF DRAWINGS

The above and other aspects, features and advantages of embodiments of the present invention will be more apparent from the following more particular description thereof, presented in conjunction with the following drawings wherein:

FIG. 1A is a diagram illustrating a head-mounted display (HMD) in accordance with some embodiments of the present invention;

FIG. 1B is a side view of FIG. 1A illustrating a head-mounted display (HMD) in accordance with some embodiments of the present invention;

FIGS. 2A and 2B are diagrams illustrating a valve and air pump in accordance with some embodiments of the present invention;

FIG. 3 is a diagram illustrating a valve in accordance with some embodiments of the present invention;

FIG. 4 is a flow diagram illustrating a method in accordance with some embodiments of the present invention;

FIG. 5 is a diagram illustrating an adjustable cushion that includes a haptics capability in accordance with some embodiments of the present invention;

FIG. 6 is a diagram illustrating an adjustable cushion that includes a haptics capability and a valve in accordance with some embodiments of the present invention; and

FIG. 7 is a block diagram illustrating a system that includes a processor-based system or apparatus that may be used to run, implement, and/or execute many of the methods, schemes, and techniques shown and described herein in accordance with some embodiments of the present invention.

### DETAILED DESCRIPTION

As mentioned above, head-mounted displays (HMDs) are often used with virtual reality (VR), augmented reality (AR), and mixed reality (MR) systems. It is not unusual for an HMD, such as a VR headset, to be worn by the user for an extended period, such as when the user is playing a VR game. In such scenarios a comfortable fit can make the experience much more enjoyable. Everyone has slightly different head shapes and facial contours, as well as individual preferences for how an HMD should fit.

In some embodiments, the present invention provides adjustable cushions for an HMD that will help to provide a secure and comfortable fit based on the preferences of the viewer, game player, or other user of the HMD. For example, in some embodiments, at least two adjustable cushions are attached to the interior of an HMD and are configured to make contact with the user's head when the HMD is worn by the user. In some embodiments, a cushion adjustment system is included that is operable and controllable by the user to adjust the size of each of the cushions as needed to achieve the desired fit. This system of adjustable cushions proposes to enhance both the fit and comfort of HMDs. When used in a VR headset, embodiments of the present invention can help to ensure that time spent in the virtual world is not degraded due to headset movement and discomfort.

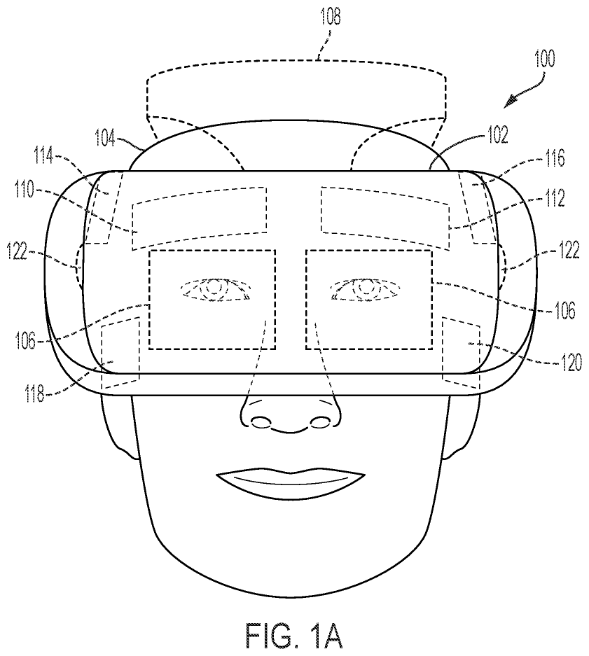

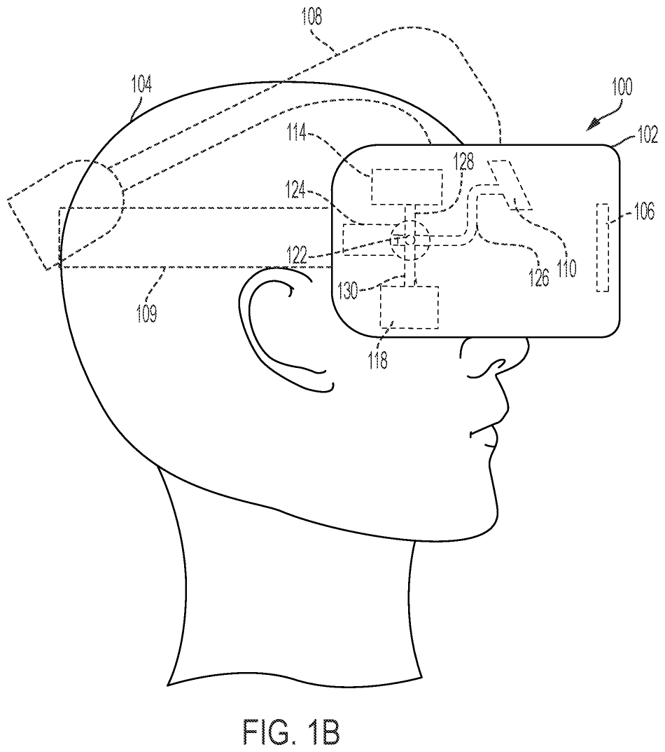

FIGS. 1A and 1B illustrate an example of an HMD 100 fitted with adjustable cushions in accordance with an embodiment of the present invention. The HMD 100 includes a housing 102 that is configured to be worn on the head 104 of a user as shown. Namely, the HMD 100 is shown as being worn on the user's head 104 over a portion of the user's face covering the user's eyes. The HMD 100 typically includes one or more displays 106 mounted in the housing 102 that are configured and positioned in a manner that allows the user's eyes to see images displayed on the one or more displays 106. In some embodiments, a mount 108 is included that supports the housing 102 and that mounts to the head 104 of the user. Alternatively, in some embodiments, a strap 109 may be included to secure the housing 102 to the head 104 of the user. The housing 102, the mount 108, and the strap 109 may comprise many different shapes and configurations in accordance with various embodiments of the present invention.

In the illustrated embodiment, the HMD 100 includes six adjustable cushions 110, 112, 114, 116, 118, and 120 attached to the housing 102 that are configured to make contact with the user's head 104. The adjustable cushions are attached to the interior of the housing 102 along the forehead (adjustable cushions 110, 112), above the ears (adjustable cushions 114, 116), and on the cheeks (adjustable cushions 118, 120). The use of six adjustable cushions in the illustrated locations is just one example configuration. Any number of adjustable cushions in any locations, positions, configurations, or contact points may be used in accordance with various embodiments of the present invention. For example, in some embodiments, only one adjustable cushion is used, and in some embodiments, more than one adjustable cushion is used. Thus, any number of adjustable cushions positioned and configured to make contact with a user's face and/or head in comfortable locations may be used.

Furthermore, the adjustable cushions may comprise any shape, size, thickness, length, etc. For example, in some embodiments, the adjustable cushions may comprise a wraparound nature and provide complementary areas of coverage that provide a comfortable fit around the contours of the wearers head and face. By way of example, in some embodiments, the adjustable cushions 110 and 112 may be shorter, or longer, or may be merged or combined together to form one adjustable cushion that runs substantially along the user's forehead. In some embodiments, the one adjustable cushion may even be further extended to wrap around towards the user's temples, ears, or other location on the side of the user's head. In some embodiments, the one adjustable cushion may be further extended and merged or combined with the adjustable cushions 114 and 116. Thus, in this later scenario, in some embodiments, the four adjustable cushions 110, 112, 114, and 116 may be combined into one large adjustable cushion. In some embodiments, that one large adjustable cushion may be the only adjustable cushion that is used. Many other combinations and configurations of adjustable cushions may be used in accordance with various embodiments of the present invention.

In the illustrated embodiment, each of the adjustable cushions 110, 112, 114, 116, 118, and 120 comprises a bladder, such as for example an air bladder or a bladder that is inflatable with some other type of gas or liquid. That is, in some embodiments, each of the adjustable cushions may be formed from and/or include an inflatable and deflatable bladder or other similar item that is inflatable and deflatable, such as a bag, cell, pocket, sac, pouch, etc. In some embodiments, each bladder may include a chamber into which air, or some other type of gas or liquid, is added and removed to respectively inflate and deflate the bladder. When air bladders are used, the adjustable cushions essentially comprise air cushions that fit inside the HMD 100 and make contact with the user's head 104 at or near, for example, the forehead, temples, cheekbones, above the ears, or any other appropriate and comfortable contact point on the user's head and/or face. In some embodiments, the bladders may be made from any suitable material that is capable of maintaining pressure, i.e., not allowing air or other gas or liquid to escape or pass through. In some embodiments, instead of using bladders, the adjustable cushions may be made adjustable by using other techniques, methods, and/or means.

As mentioned above, some embodiments include a cushion adjustment system that is operable and controllable by the user to adjust the size of each of the adjustable cushions. In the illustrated embodiment, a cushion adjustment system is included that is configured to adjust the size of each of the adjustable cushions 110, 112, 114, 116, 118, and 120 in order to achieve the desired fit of the housing 102 and HMD 100 on the head 104 of the user. In some embodiments, the cushion adjustment system is capable of adjusting the cushions to each be different or the same sizes and to maintain the different or same sizes, which can help to achieve the desired fit. In some embodiments, the cushion adjustment system is configured to sense information indicative of a current size of each adjustable cushion. And in some embodiments, the cushion adjustment system is operable and controllable by the user while the user is wearing the HMD 100.

In some embodiments, such as the illustrated embodiment where each of the adjustable cushions comprises a bladder, the cushion adjustment system comprises an inflation system. In the illustrated embodiment, the cushion adjustment system comprises an inflation system having two valves 122 and two air pumps 124. The inflation system is configured to adjust the size of each of the adjustable cushions 110, 112, 114, 116, 118, and 120 by adjusting an amount of pressure in the bladder associated with each of the adjustable cushions.

In the illustrated embodiment, one valve 122 and one air pump 124 are located on each side of the housing 102 on each side of the user's head 104. Each valve 122 and air pump 124 combination is used to inflate the three nearby adjustable cushions. For example, as shown in FIG. 1B, the valve 122 and air pump 124 combination on the user's right side is used to inflate the three adjustable cushions 110, 114, and 118. In some embodiments, the valve 122 and/or air pump 124 are situated between the adjustable cushions 110, 114, and 118. This allows easy access to the valve 122 by the user with his or her hands while he or she is wearing the HMD 100. As such, the valves are operable and controllable by the user to adjust the size of each of the adjustable cushions while the user is wearing the HMD 100.

Inflation and deflation of the adjustable cushions is accomplished by air tubes that connect the valve 122 to each of the adjustable cushions. For example, as illustrated, an air tube 126 connects the valve 122 to the adjustable cushion 110, an air tube 128 connects the valve 122 to the adjustable cushion 114, and an air tube 130 connects the valve 122 to the adjustable cushion 118. In some embodiments, the valves 122 and air pumps 124 are configured to be capable of maintaining different amounts of pressure in each of the bladders corresponding to each of the adjustable cushions, which allows the adjustable cushions 110, 112, 114, 116, 118, and 120 to be adjusted to different sizes. In some embodiments, the valves 122 and air pumps 124 are configured to be capable of maintaining the same amounts of pressure in each of the bladders. As such, the inflation system can be used to inflate or deflate each of the bladders based on the fit preferences of the viewer, game player, or other user.

While the illustrated embodiment uses two valves 122 and two air pumps 124, any number of valves and air pumps may be used in accordance with various embodiments of the present invention. For example, one valve 122 and one air pump 124 may be used to inflate and deflate all six of the adjustable cushions 110, 112, 114, 116, 118, and 120, or three or more valves 122 and air pumps 124 may be used.

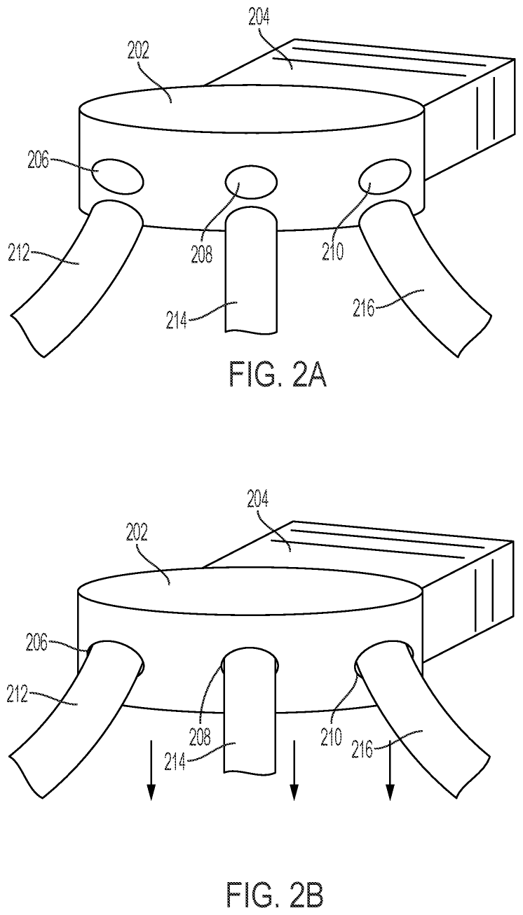

FIGS. 2A and 2B illustrate an example of a valve 202 and an air pump 204 in accordance with an embodiment of the present invention. In some embodiments, the valve 202 and air pump 204 may be used for the valve 122 and air pump 124 shown in FIG. 1B. In some embodiments, the air pump 204 is driven by a motor (not shown) and may be referred to as a motorized air pump. The valve 202 includes three openings 206, 208, and 210, for engagement with three air tubes 212, 214, and 216 for driving three adjustable cushions. Air pressure is activated by pushing down on the valve 202. Namely, in FIG. 2A the valve 202 has not yet been pushed down, and so the openings 206, 208, and 210 in the valve are not connected to the three air tubes 212, 214, and 216. In FIG. 2B the valve 202 has been pushed down, which connects the openings 206, 208, and 210 in the valve to the three air tubes 212, 214, and 216. Thus, pushing down on the valve 202 engages the valve to the air tubes and allows air to be pumped into the bladders of the adjustable cushions.

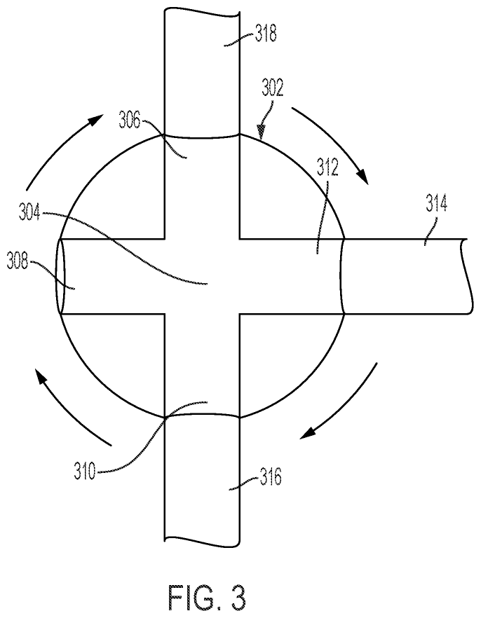

FIG. 3 illustrates an example of another type of valve 302 that may be used for an inflation system in accordance with an embodiment of the present invention. The valve 302, which may be used in combination with the motorized air pump discussed above, operates by spinning to activate air flow. Specifically, a rotating portion 304 of the valve 302 includes three closed valve portions 306, 308, and 310, and one open valve portion 312. The open valve portion 312 rotates among the three air tubes 314, 316, and 318 that connect to three adjustable cushions. The open valve portion 312 inflates the bladder for one of the adjustable cushions to the desired fit and is then rotated to the next air tube to inflate the next adjustable cushion. This configuration allows the bladders to be inflated to different pressures, which allows the adjustable cushions to be adjusted to different sizes. After the three adjustable cushions have each been inflated to the desired fit, the valve is rotated so that the three closed valve portions 306, 308, and 310 connect to the three air tubes 316, 314, and 318. That is, each air tube is connected to one of the closed valve portions. With each air tube connected to a closed valve portion, the air pressure is maintained in each of the bladders of the adjustable cushions.

In some embodiments, the rotating portion 304 of the valve 302 may be rotated manually by the user. For example, the user may use his or her hands to rotate the valve while he or she is wearing the HMD. This allows the user to adjust the size of each of the adjustable cushions as needed to achieve the desired fit.

In some embodiments, the rotating portion 304 of the valve 302 is capable of rotating automatically. In some embodiments, the valve 302 and its rotating portion 304, as well as an associated motorized air pump, are capable of being automatically controlled by an associated system. This allows the adjustable cushions to be automatically adjusted by the system, such as to a predetermined size, a previously saved size, or a default size, which will be discussed below.

Regardless of which type of valve is used, the bladders of the adjustable cushions are inflated by pumping air into the bladders and are deflated by removing air. In some embodiments, the valves may include buttons or the like (not shown) that are used to inform the motorized air pump to adjust the directional flow, as necessary, to inflate or deflate the bladders. For example, the motorized air pump may be reversed to deflate the bladders.

In some embodiments, the valve/air pump combinations include air pressure readers for measuring the air pressure in each of the bladders of the adjustable cushions. By way of example, the pressure may be measured in pounds per square inch (PSI) or any other unit of pressure. In some embodiments, the air pressure in each of the adjustable cushions can be read separately. Measuring the air pressure in each of the bladders is one way of sensing information indicative of a current size of each of the adjustable cushions.

In some embodiments, the sensed information indicative of a current size of each of the adjustable cushions can be saved, such as by a processor-based system. As such, in some embodiments, the cushion adjustment system is further configured to communicate with a processor-based system for saving the information indicative of a current size of each of the adjustable cushions. In some embodiments, the saving of such information is accomplished by saving the measured air pressure of each of the bladders of the adjustable cushions.

Saving information indicative of a current size of each of the adjustable cushions, such as the measured air pressure of each of the bladders, allows such information to be retrieved and used later. For example, in some embodiments, the cushion adjustment system includes the ability to automatically adjust the size of the adjustable cushions. With this ability, the cushion adjustment system can automatically adjust the size of the adjustable cushions to a previously saved size. In some embodiments, the cushion adjustment system performs such automatic adjusting of the adjustable cushions in response to input received from a processor-based system.

For example, a user may spend time manually adjusting and fine tuning the sizes of the adjustable cushions to achieve a desired fit of the HMD. Those settings and adjustments can then be memorized, i.e., saved. For example, the user may press a button on a system user interface or take similar action to save the settings. Then, the next time the user uses the HMD, the settings are retrieved, and the cushions are automatically adjusted to the user's preferred fit. This saves the user from having to adjust the cushions again manually. It also makes it easier to switch between users and retain unique comfort settings. For example, different users of the same HMD, such as a VR headset, could each save their preferred cushion size settings. Then, when switching users, the next user's settings are retrieved, and the cushions are automatically adjusted to the next user's preferred fit.

In embodiments where each of the adjustable cushions comprises a bladder, activation for future use, such as for the next user, is simplified by reverting to memorized PSI settings. Namely, once a comfortable fit is achieved, a user can save these settings (measured by PSI), and with one touch, the valve/air pump combination will automatically recreate the fit based on saved PSI values. Thus, for example, a VR headset can be easily passed between game players with the cushions in the headset being automatically adjusted to each player's preferred settings.

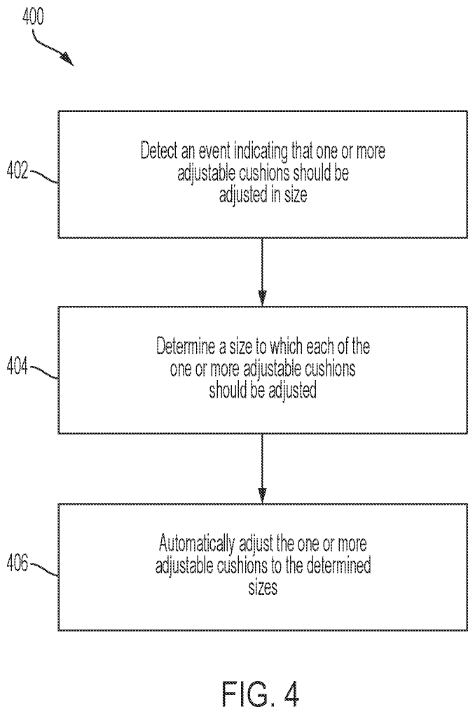

The feature of automatically adjusting the sizes of the adjustable cushions in an HMD has several different uses and applications in accordance with various embodiments of the present invention. For example, there are several different types of events that can trigger the cushions to be automatically adjusted. Examples of some of these events will be discussed with reference to FIG. 4, which illustrates a method 400 in accordance with an embodiment of the present invention.

In some embodiments, the method 400 is executed by a system that includes a processor-based system or apparatus and one or more associated HMDs, such as one or more VR, AR, or MR headsets. An example of a processor-based system or apparatus will be discussed below.

The method 400 begins with step 402 in which the system detects an event indicating that one or more adjustable cushions attached to an interior of an HMD should be adjusted in size. The event may indicate that any number of the adjustable cushions should be adjusted in size, such as only one cushion, some of the cushions, or all the cushions. A first example of such an event is when the system detects that a current user of the HMD has completed use of the HMD. In some embodiments, this situation triggers an automatic quick reduction in the size of the adjustable cushions to help ensure a comfortable release of the HMD from the user's head. In some embodiments, an automatic quick reduction in the size of the adjustable cushions can be accomplished by an automatic quick deflation of the bladders associated with the adjustable cushions.

There are several different ways the system can detect that a current user of the HMD has completed use of the HMD. In some embodiments, a movement sensor is included on the HMD to detect when the user has completed use. For example, the movement sensor may detect when the user puts both of his or her hands on the HMD to try to take it off. Detecting such a hand movement would trigger a quick deflation of the cushions. As another example, the movement sensor or a camera may detect that the user has stopped interacting with a currently running software application, such as a game application. In some embodiments, a physical button may be included on the HMD that the user can press to trigger a quick deflation of the cushions. In some embodiments, an on-screen button may be included that the user can press to trigger a quick deflation of the cushions.

In some embodiments, the system detects that the current user has completed use of the HMD by detecting on the system side that the user has stopped interacting with the game or other software application. Or, in some embodiments, the system detects the completion of use of the HMD because the current user has indicated to the system via user input the completion of use, such as by closing an application or game, or a similar action. Thus, in some embodiments, detecting that a current user of the HMD has completed use of the HMD may be based on one or more of user input data, camera data, or data from a sensor.

When the system detects the completion of use of the HMD, the reduction in the size of the adjustable cushions can either be a partial reduction or a complete reduction. In either case, the resulting size of the cushions will typically be smaller than before the event was detected, which should help to ease the release of the HMD from the user's head.

An example of another event indicating that one or more of the adjustable cushions in an HMD should be adjusted in size is when the system detects a next user of the HMD. In some embodiments, this situation triggers the adjustable cushions in the HMD to be automatically adjusted for the next user.

In some embodiments, the detecting a next user of the HMD may be based on one or more of user input data, user profile data, biometrics data, camera data, and/or data from a sensor. For example, the next user may manually alert the system that he or she intends to use the HMD. The next user can manually alert the system by, for example, providing input, such as user profile data or other input data, to the system via a user interface or the like, such as for example an on-screen interface or a voice recognition interface. As another example, a next user of the HMD may be automatically detected by the system. Such detection can occur by the system monitoring any available cameras, sensors, or similar devices for an indication of a next user's intention to use the HMD. For example, a camera may capture images of a next user picking up the HMD, or a movement sensor on the HMD may detect a next user picking up the HMD. As another example, if one user is passing a headset to a different user, any available camera or sensor may see the exchange and know that the user of the headset is changing. Any available camera or sensor may be used, such as may be included with the system or any device associated with a user, such as a mobile phone, smartphone, or other device.

An example of another event indicating that one or more adjustable cushions in an HMD should be adjusted in size is when the system receives data from a sensor on the HMD indicating that one or more of the adjustable cushions should be adjusted. For example, in some embodiments, the sensor on the HMD may comprise an inertial measurement unit (IMU). Data from the IMU may indicate that the HMD is not fitted properly on the user's head. For example, data from the IMU may indicate that the HMD is loose, shifting, vibrating, or otherwise moving with respect to the user's head and is not secure. As another example, data from the IMU may indicate that head movements are causing a decoupling of the HMD from the user's head. In some embodiments, this situation triggers one or more of the adjustable cushions in the HMD to be automatically adjusted to make the HMD more secure. For example, for air bladder-based cushions the air pressure in one of more of the cushions can be increased to see if that makes the HMD more secure.

The next step in the method 400 is step 404. In this step, in response to the detection of an event, the system determines a size to which each of the one or more adjustable cushions should be adjusted. The size to which each of the adjustable cushions should be adjusted may be determined based on several factors, including but not limited to a previously saved size, a predetermined size, preset size configurations, default size options, user input data, user profile data, or biometrics data. For example, as discussed above, when the system detects that a current user of the HMD has completed use of the HMD, the system will determine a reduced size for the cushions to help ease the release of the HMD from the user's head. In some embodiments, the reduced size may comprise a predetermined size. In some embodiments, the reduced size may comprise a reduction or a percentage reduction in the PSI in the bladders associated with the adjustable cushions, such as for example a reduction in the PSI of at least 40%, or 50%, or 60%, or any other percentage, percentage range, PSI, or PSI range.

In some embodiments, the size to which each of the adjustable cushions should be adjusted may be determined based on user input data. For example, a user may provide his or her preferred cushion size information to the system through a user interface or the like, such as for example an on-screen interface or a voice recognition interface.

In some embodiments, in order to determine the sizes for each of the adjustable cushions, the system first determines an identity of a next user of the HMD. In some embodiments, the identity of a next user of the HMD may be determined based on one or more of user input data, user profile data, or biometrics data. For example, the next user may provide his or her identity to the system through a user interface or the like. Or the next user may provide his or her identity to the system by way of biometrics, such as by a fingerprint scanner, facial recognition, retina scans, etc. Any available fingerprint scanner or camera may be used, such as any device associated with the system or a user's mobile phone, smartphone, or other device.

In some embodiments, the system automatically detects the identity of the next user by way of biometrics. For example, the system may use any available cameras or other sensors to automatically identify the next user by facial recognition. For example, a system may detect that one user is finished using the HMD and is handing it to the next user. In this scenario the system may use any available cameras or sensors to detect the identity of the next user. Namely, if one user is passing a headset to a different user, any available camera or sensor may see the exchange and identify the next user by facial recognition. This way the system can start to determine cushion sizes and automatically adjust the cushions for the next user as soon as the camera sees the next user grabbing the headset.

In some embodiments, if the system has detected the identity of the next user, the system can then access or search for a user profile for the user which may include the user's preferred HMD cushion size information. In some embodiments, the system searches for a user profile across social media platforms, online user groups, communities, etc. In some embodiments, a user profile includes previously saved HMD cushion size information. For example, a user may have previously manually adjusted the cushions of an HMD to achieve a desired fit, and then saved the size information in his or her user profile. Thus, this is an example of how the size to which each of the adjustable cushions should be adjusted can be determined based on user profile data. Automatically retrieving previously saved HMD cushion size information can make it easier to switch between players or other users and retain unique comfort settings.

In some embodiments, the size to which one or more of the adjustable cushions should be adjusted is determined based on biometrics data. For example, in some embodiments, the system uses any available cameras or sensors to scan the contours of the user's face and/or head. Any available camera or sensor may be used, such as any device associated with the system or a user's mobile phone, smartphone, or other device. In some embodiments, the system then uses the data from the scan to predict and/or estimate HMD cushion size information for the user. In some embodiments, the system uses the data from the scan to select from one or more preset configurations or default HMD cushion size options that would be appropriate for the user. Thus, in some embodiments, one or more preset or default HMD cushion size options are determined in advance and then selected for a user, such as for example a previously unknown user.

In some embodiments, the one or more preset configurations or default HMD cushion size options may be determined based on crowdsourcing. Specifically, it is believed that there will eventually be a range of cushion size settings that people have deemed comfortable. Such settings can be categorized in terms of similar head shapes and head sizes to develop the preset configurations and default size options.

In some embodiments, the size to which one or more of the adjustable cushions should be adjusted may be determined based on at least one of, or any combination of, user input data, user profile data, or biometrics data. For example, in some embodiments the user may use a user interface to indicate to the system that he or she will use the HMD and also provides or directs the system to his or her user profile that includes preferred HMD cushion size information for the user. In some embodiments, the user may prompt the system to determine his or her identity or facial features from a mobile phone's fingerprint scanner or camera. The system can then automatically locate a user profile (which may include a previously saved size setting), select a default cushion size setting, or estimate a cushion size setting for the user.

The next step in the method 400 is step 406. In this step, the system automatically adjusts the one or more adjustable cushions to the size determined for each of the one or more adjustable cushions. In some embodiments, the automatic adjusting is performed by automatically adjusting an amount of pressure in a bladder associated with each of the adjustable cushions. In some embodiments, this can be accomplished by using one of the valve/air pump combinations described above. In such embodiments, the valve/air pump combination may be configured to be automatically controlled and operated by the system.

In some embodiments, the system waits until the user puts on the HMD before automatically adjusting the sizes of the adjustable cushions. This is because the desired fit of the HMD may be a somewhat snug fit. Waiting to increase the size of the adjustable cushions, such as by keeping the associated bladders deflated, makes it easier for the user to put the HMD on his or her head. Once the user is wearing the HMD, the system can then automatically adjust the sizes of the cushions to achieve the desired fit.

After the system automatically adjusts each of the adjustable cushions to the determined size, the user may want to fine tune the adjustments to achieve the desired fit of the HMD on the user's head. The user may want to fine tune the adjustments no matter what the determined sizes were based on, e.g., a previously saved size, an estimated size, a preset configuration, a default size, etc. Furthermore, the user may want to adjust any number of the adjustable cushions, such as only one cushion, some of the cushions, or all the cushions. In some embodiments, the user can manually adjust the sizes of one or more of the adjustable cushions using his or hands as described above. In some embodiments, the system can automatically further adjust one or more of the adjustable cushions in response to input from the user. In some embodiments, the input from the user may comprise input via a user interface, voice recognition, or other similar input. Once the user achieves the desired fit, he or she can save the size settings to, for example, update previously saved size settings.

Turning to another aspect of the teachings herein, in some embodiments one or more of the adjustable cushions may comprise a haptics capability. That is, in some embodiments, one or more of the adjustable cushions may be used to provide haptic feedback to the user of the HMD. For example, if the HMD comprises a VR headset and the user is playing a VR game, then the haptic feedback may comprise any type of haptic sensation needed for the game. Examples could include boxing, swimming, or even a “spidey-sense” tingling sensation. It is believed that providing haptic feedback via the adjustable cushions in an HMD will enhance the experience of the player or other user.

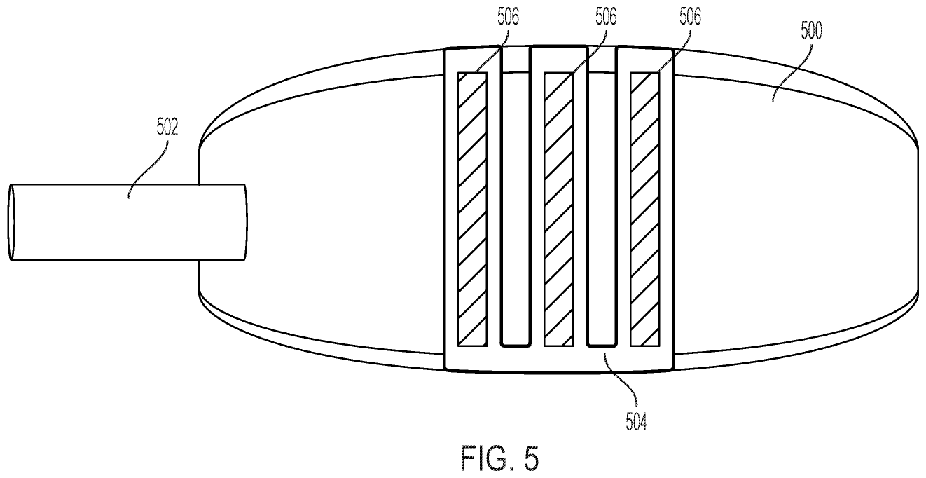

FIG. 5 illustrates an example of an adjustable cushion 500 to which a haptics capability has been added in accordance with an embodiment of the present invention. In the illustrated embodiment, the adjustable cushion 500 is of a type that comprises an air bladder, and as such a connector air tube 502 is included to inflate and deflate the bladder. The adjustable cushion 500 is encased with a vibration device that includes a base 504 connecting to and/or supporting rods 506 that extend around the adjustable cushion 500. A vibration power source (not shown) is located within or wired to the shared base 504 of the rods 506. As the powered base 504 shakes, the vibration carries up the rods 506, providing a sensation to the wearer. That is, the vibration of the rods 506 delivers a haptic sensation to the player or other user. In some embodiments, the vibration power source may comprise a variable vibration power source, which can provide a variable haptic sensation to the player or other user.

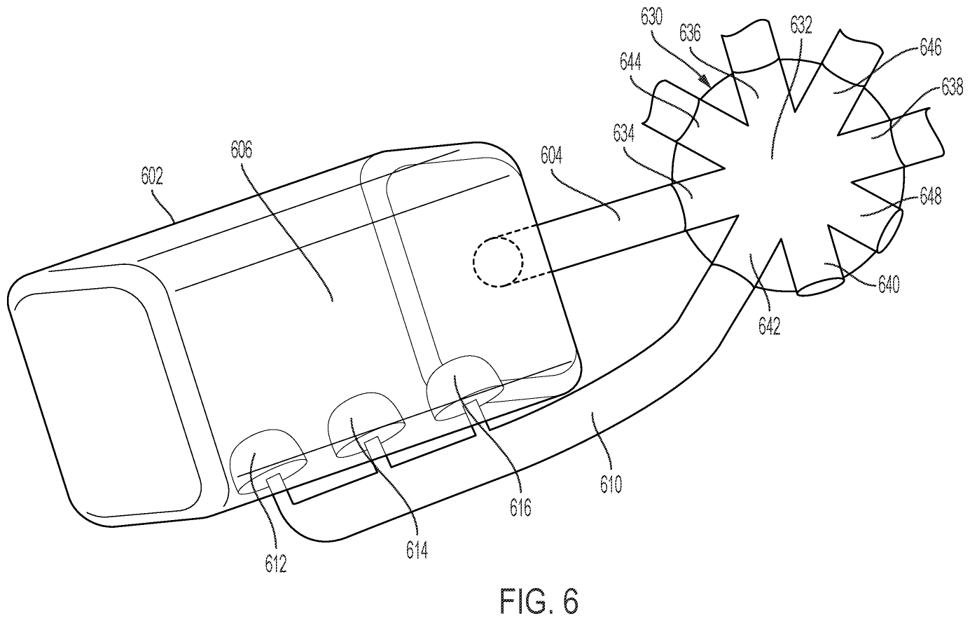

FIG. 6 illustrates another example of an adjustable cushion 602 to which a haptics capability has been added in accordance with an embodiment of the present invention. In the illustrated embodiment, the adjustable cushion 602 comprises an air bladder, and two air tubes are included. A main air tube 604 feeds the main chamber 606 of the air bladder and is used to inflate and deflate the bladder to ensure fit and comfort. A haptics air tube 610 feeds three air cells 612, 614, and 616 located within the main chamber 606 of the air bladder. The haptics air tube 610 allows the three air cells 612, 614, and 616 to be inflated and deflated separately from the main chamber 606 of the air bladder.

Once fit is established by adjusting the air pressure in the main chamber 606 of the air bladder with the main air tube 604, air intake and release through the haptics air tube 610 can create a haptic sensation for the player or other user. Namely, the air cells 612, 614, and 616 expand, creating pressure within the adjustable cushion 602. Various different haptic sensations can be created by inflating and deflating the three air cells 612, 614, and 616 at various different rates and patterns, or by pulsing air at various different rates and patterns. Generating haptic sensations in this way can create a more subtle, delicate, or gentle experience. While three air cells are used in the illustrated example, any number of air cells may be used. Furthermore, the air cells may comprise many different shapes and sizes.

Also shown in FIG. 6 is a valve 630 in accordance with an embodiment of the present invention. The valve 630, which may be used in combination with the motorized air pump discussed above, controls air flow to and from the main air tube 604 and the haptics air tube 610. The valve operates by rotating to activate air flow, similar to the valve 302 discussed above and shown in FIG. 3.

More specifically, the illustrated valve 630 is configured to supply air to three adjustable cushions that each have interior air cells for haptics (only one such adjustable cushion 602 is shown). The valve 630 comprises an eight-point valve with a rotating portion 632 that includes four main air tube connectors 634, 636, 638, and 640, and four haptics air tube connectors 642, 644, 646, and 648. Of the four main air tube connectors 634, 636, 638, and 640, three are closed valve (636, 638, and 640) and one is open valve (634). As such, the main chamber of only one of the adjustable cushions can be inflated at a time. In the illustrated example, the open valve main air tube connector 634 is currently connected to the main air tube 604, which means the main chamber 606 can currently be inflated and deflated. The rotating portion 632 of the valve 630 is then rotated to move the open valve main air tube connector 634 to inflate the main chambers of the other two associated adjustable cushions (not shown).

Of the four haptics air tube connectors 642, 644, 646, and 648, three are open valve (642, 644, and 646) and one is closed valve (648). This means that the interior haptics air cells of all three of the associated adjustable cushions can be simultaneously controlled, i.e., inflated and deflated.

In some embodiments, similar to the valve 302 (FIG. 3), the rotating portion 632 of the valve 630 may be rotated manually by the user, which for example, allows the user to use his or her hands to rotate the valve while he or she is wearing the HMD. In some embodiments, the valve 630 and its rotating portion 632, as well as an associated motorized air pump, are capable of being automatically controlled by an associated system. This allows the adjustable cushions to be automatically adjusted by the system, such as to a predetermined size, a previously saved size, or a default size. Furthermore, it also allows the interior haptics air cells of the associated adjustable cushions to be automatically controlled by the system. Thus, the system can automatically control the inflation and deflation of the interior haptics air cells to create various different haptic sensations.

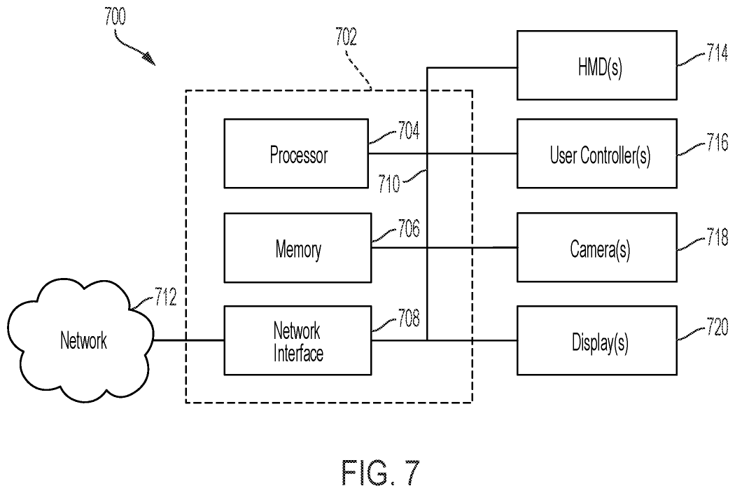

It was mentioned above that the method 400 (FIG. 4) may be executed by a system that includes a processor-based system or apparatus and one or more associated HMDs, such as one or more VR, AR, or MR headsets. FIG. 7 illustrates an example of such a system 700 in accordance with an embodiment of the present invention. In some embodiments, the system 700 may be used for implementing, executing, or practicing many of the methods, schemes, techniques, systems, or devices described herein. However, the use of the system 700 or any portion thereof is certainly not required.

The system 700 includes a processor-based system or apparatus 702. In some embodiments, the processor-based system or apparatus 702 may comprise an entertainment system, game console, gaming computer, desktop computer, notebook computer, workstation, server, portable device, mobile device, pad-like device, smartphone, etc. In some embodiments, the processor-based system or apparatus 702 may be included in its associated HMD or separate from its associated HMD.

In some embodiments, the processor-based system or apparatus 702 includes a processor 704 (e.g., a central processing unit (CPU)), a memory 706, and a wireless and/or wired network interface 708. In some embodiments, the components communicate with each other via connections and/or communications channels 710, which may comprise wired connections, wireless connections, network connections, or a mixture or combination of both wired and wireless connections, communications channels, network connections, buses, etc.

The processor 704 may be used to execute or assist in executing the steps of the methods, schemes, and techniques described herein. For example, in some embodiments, the processor 704 executes code, software, or steps that implements, carries out, and/or facilitates the detection of events indicating needed adjustment of adjustable cushions, the determination of sizes for the adjustable cushions, and the automatic adjustment of the cushion sizes, as described above.

The memory 706 may include or comprise any type of computer readable storage or recording medium or media. In some embodiments, the memory 706 may include or comprise a tangible, physical memory. In some embodiments, the memory 706 may be used for storing program or computer code or macros that implements the methods and techniques described herein, such as program code for running the methods, schemes, and techniques described herein. In some embodiments, the memory 706 may serve as a tangible non-transitory computer readable storage medium for storing or embodying one or more computer programs or software applications for causing a processor-based apparatus or system to execute or perform the steps of any of the methods, code, schemes, and/or techniques described herein. Furthermore, in some embodiments, the memory 706 may be used for storing any needed database(s).

In some embodiments, the wireless and/or wired network interface 708 may be used for accessing a network, such as for example the network 712. The network 712 may comprise the Internet, a local area network, a home network, an office network, a gaming network, an intranet, a wide area network, or any other network. Any type of information or data may be downloaded or uploaded to the network 712, such as for example, user profile data, biometrics data, preset size configurations, default size options, or any other information needed for implementing and/or running the methods, schemes, and/or techniques discussed herein.

In some embodiments, the system 700 includes one or more head-mounted displays (HMDs) 714. In some embodiments, one or more of the HMDs 714 may be fitted with one or more adjustable cushions as described above. For example, in some embodiments, motorized air bladders may be attached to the interior of one or more of the HMDs 714 along the forehead, temples, cheeks, above the ears, and/or any other locations or positions as described above. The HMDs 714 may comprise any type of head worn device, apparatus, or object, such as for example user headset devices, glasses-type user devices, any type of VR, AR, and/or MR head worn device, etc. In some embodiments, each HMD 714 may include one or more displays. In some embodiments, each HMD 714 may optionally include other components, such as for example one or more of the following: microphone(s), audio headphones, audio earbuds, audio speaker(s), camera(s), inertial measurement unit(s) (IMU(s)), inertial sensor(s), electromagnetic (EM) tracking transmitter(s), EM tracking receiver(s), other sensor(s), networking device(s), haptics device(s), motor(s), vibration or motion device(s), fan(s), transmitter(s), receiver(s), or other electronics or systems.

In some embodiments, the system 700 includes one or more user controller(s) 716. The user controller 716 may comprise any type of controller, such as for example a handheld controller, handheld controller set, UI controller, game pad, game controller, wand, or similar device. In some embodiments, the user controller 716 may include one or more of any of the following components: inertial measurement unit(s) (IMU(s)), inertial sensor(s), EM tracking transmitter(s), EM tracking receiver(s), microphone(s), audio speaker(s), camera(s), haptics device(s), or other electronics or systems.

In some embodiments, the system 700 includes one or more cameras 718. The one or more cameras 718 may comprise any type of cameras or image capture devices. In some embodiments, the one or more cameras 718 may be used for recognizing and/or identifying users of an HMD, such as by facial recognition, as described above. In some embodiments, the one or more cameras 718 may be included or associated with a device such as an entertainment system, game console, gaming computer, smartphone, mobile device, tablet computer, pad-like computer, notebook computer, desktop computer, etc. In some embodiments, the one or more cameras 718 may be located or positioned on an HMD, headset, glasses-type user device, or elsewhere in a VR, AR, or MR environment or room.

In some embodiments, the system 700 includes one or more displays 720. The one or more displays 720 may comprises any type of display devices using any type of display technology and may be used for implementing any needed environments. In some embodiments, the one or more displays 720 may be included or associated with a device such as an entertainment system, game console, gaming computer, television, smartphone, mobile device, tablet computer, pad-like computer, notebook computer, desktop computer, etc.

In some embodiments, one or more of the embodiments, methods, approaches, schemes, and/or techniques described above may be implemented in one or more computer programs or software applications executable by a processor-based apparatus or system. By way of example, such processor-based system may comprise a smartphone, tablet computer, VR, AR, or MR system, entertainment system, game console, mobile device, computer, workstation, gaming computer, desktop computer, notebook computer, server, graphics workstation, client, portable device, pad-like device, communications device or equipment, etc. Such computer program(s) or software may be used for executing various steps and/or features of the above-described methods, schemes, and/or techniques. That is, the computer program(s) or software may be adapted or configured to cause or configure a processor-based apparatus or system to execute and achieve the functions described herein. For example, such computer program(s) or software may be used for implementing any embodiment of the above-described methods, steps, techniques, schemes, or features. As another example, such computer program(s) or software may be used for implementing any type of tool or similar utility that uses any one or more of the above-described embodiments, methods, approaches, schemes, and/or techniques. In some embodiments, one or more such computer programs or software may comprise a VR, AR, or MR application, communications application, object positional tracking application, a tool, utility, application, computer simulation, computer game, video game, role-playing game (RPG), other computer simulation, or system software such as an operating system, BIOS, macro, or other utility. In some embodiments, program code macros, modules, loops, subroutines, calls, etc., within or without the computer program(s) may be used for executing various steps and/or features of the above-described methods, schemes and/or techniques. In some embodiments, such computer program(s) or software may be stored or embodied in a non-transitory computer readable storage or recording medium or media, such as a tangible computer readable storage or recording medium or media. In some embodiments, such computer program(s) or software may be stored or embodied in transitory computer readable storage or recording medium or media, such as in one or more transitory forms of signal transmission (for example, a propagating electrical or electromagnetic signal).

Therefore, in some embodiments the present invention provides a computer program product comprising a medium for embodying a computer program for input to a computer and a computer program embodied in the medium for causing the computer to perform or execute steps comprising any one or more of the steps involved in any one or more of the embodiments, methods, approaches, schemes, and/or techniques described herein. For example, in some embodiments the present invention provides one or more non-transitory computer readable storage mediums storing one or more computer programs adapted or configured to cause a processor-based apparatus or system to execute steps comprising any one or more of the embodiments, methods, approaches, schemes, and/or techniques described herein.

While the invention herein disclosed has been described by means of specific embodiments and applications thereof, numerous modifications and variations could be made thereto by those skilled in the art without departing from the scope of the invention set forth in the claims.

What is claimed is:

1. An apparatus, comprising:
one or more displays;
a housing to which the one or more displays are mounted, wherein the housing is configured to be worn on the head of a user in a manner that allows the user's eyes to see images displayed on the one or more displays;
at least two adjustable cushions attached to the housing and configured to make contact with the user's head when the housing is worn on the head of the user; and
a cushion adjustment system configured to adjust a size of each of the at least two adjustable cushions to achieve a desired fit of the housing on the head of the user.

2. The apparatus of claim 1, wherein the cushion adjustment system is further configured to be controllable by the user to adjust the size of each of the at least two adjustable cushions as needed to achieve the desired fit of the housing on the head of the user.

3. The apparatus of claim 1, wherein the cushion adjustment system is further configured to be capable of maintaining different sizes for each of the at least two adjustable cushions.

4. The apparatus of claim 1, wherein the cushion adjustment system is further configured to sense information indicative of a current size of each of the at least two adjustable cushions.

5. The apparatus of claim 4, wherein the cushion adjustment system is further configured to communicate with a system for saving the information indicative of a current size of each of the at least two adjustable cushions.

6. The apparatus of claim 1, wherein the cushion adjustment system is further configured to automatically adjust the size of each of the at least two adjustable cushions.

7. The apparatus of claim 1, wherein each of the at least two adjustable cushions comprises a bladder.

8. The apparatus of claim 7, wherein the cushion adjustment system comprises an inflation system configured to adjust the size of each of the at least two adjustable cushions by adjusting an amount of pressure in the bladder associated with each of the at least two adjustable cushions.

9. The apparatus of claim 8, wherein the inflation system is further configured to be capable of maintaining different amounts of pressure in each of the bladders.

10. The apparatus of claim 1, wherein one or more of the at least two adjustable cushions comprises a haptics capability.

11. The apparatus of claim 1, wherein one or more of the at least two adjustable cushions comprises:
a bladder; and
at least one air cell located within the bladder, wherein the air cell is configured to be inflated separately from the bladder.

12. A method, comprising:
detecting an event indicating that one or more adjustable cushions attached to an interior of a head-mounted display (HMD) should be adjusted in size, wherein the HMD includes at least two adjustable cushions configured to make contact with a user's head when the HMD is worn on the user's head;
in response to the detecting an event, determining a size to which each of the one or more adjustable cushions should be adjusted; and
automatically adjusting the one or more adjustable cushions to the size determined for each of the one or more adjustable cushions.

13. The method of claim 12, wherein the detecting an event indicating that one or more adjustable cushions attached to an interior of a head-mounted display (HMD) should be adjusted in size comprises:
detecting that a current user of the HMD has completed use of the HMD.

14. The method of claim 13, wherein the detecting that a current user of the HMD has completed use of the HMD comprises:
detecting that the current user of the HMD has completed use of the HMD based on one or more of user input data, camera data, or data from a sensor.

15. The method of claim 12, wherein the detecting an event indicating that one or more adjustable cushions attached to an interior of a head-mounted display (HMD) should be adjusted in size comprises:
detecting a next user of the HMD.

16. The method of claim 15, wherein the detecting a next user of the HMD comprises:
detecting the next user of the HMD based on one or more of user input data, user profile data, biometrics data, camera data, or data from a sensor.

17. The method of claim 12, wherein the detecting an event indicating that one or more adjustable cushions attached to an interior of a head-mounted display (HMD) should be adjusted in size comprises:
receiving data from a sensor on the HMD indicating that the one or more adjustable cushions should be adjusted.

18. The method of claim 17, wherein the sensor comprises an inertial measurement unit (IMU).

19. The method of claim 12, wherein the determining a size to which each of the one or more adjustable cushions should be adjusted comprises:
determining the size to which each of the one or more adjustable cushions should be adjusted based on one or more of user input data, user profile data, biometrics data, preset size configurations, or default size options.

20. The method of claim 12, wherein the determining a size to which each of the one or more adjustable cushions should be adjusted comprises:
determining an identity of a next user of the HMD.

21. The method of claim 20, wherein the determining an identity of a next user of the HMD comprises:
determining the identity of the next user of the HMD based on one or more of user input data, user profile data, or biometrics data.

22. The method of claim 12, wherein the automatically adjusting the one or more adjustable cushions to the size determined for each of the one or more adjustable cushions comprises:
waiting until a next user puts on the HMD before automatically adjusting the one or more adjustable cushions to the size determined for each of the one or more adjustable cushions.

23. The method of claim 12, wherein:
each of the at least two adjustable cushions comprises a bladder; and
the automatically adjusting the one or more adjustable cushions to the size determined for each of the one or more adjustable cushions comprises adjusting an amount of pressure in the bladder associated with each of the one or more adjustable cushions.

24. The method of claim 12, further comprising:
further adjusting any of the at least two adjustable cushions in response to input from the user to achieve a desired fit of the HMD on the user's head.

25. A non-transitory computer readable storage medium storing one or more computer programs configured to cause a processor-based system to execute steps comprising:
detecting an event indicating that one or more adjustable cushions attached to an interior of a head-mounted display (HMD) should be adjusted in size, wherein the HMD includes at least two adjustable cushions configured to make contact with a user's head when the HMD is worn on the user's head;
in response to the detecting an event, determining a size to which each of the one or more adjustable cushions should be adjusted; and
automatically adjusting the one or more adjustable cushions to the size determined for each of the one or more adjustable cushions.

26. The non-transitory computer readable storage medium of claim 25, wherein the detecting an event indicating that one or more adjustable cushions attached to an interior of a head-mounted display (HMD) should be adjusted in size comprises:
detecting that a current user of the HMD has completed use of the HMD.

27. The non-transitory computer readable storage medium of claim 25, wherein the detecting an event indicating that one or more adjustable cushions attached to an interior of a head-mounted display (HMD) should be adjusted in size comprises:
detecting a next user of the HMD.

28. The non-transitory computer readable storage medium of claim 25, wherein the determining a size to which each of the one or more adjustable cushions should be adjusted comprises:
determining the size to which each of the one or more adjustable cushions should be adjusted based on one or more of user input data, user profile data, biometrics data, preset size configurations, or default size options.

29. A system, comprising:
a head-mounted display (HMD) that includes at least two adjustable cushions attached to an interior of the HMD that are configured to make contact with a user's head when the HMD is worn on the user's head; and
a processor-based system configured to execute steps comprising,
detecting an event indicating that one or more of the at least two adjustable cushions should be adjusted in size;
in response to the detecting an event, determining a size to which each of the one or more of the at least two adjustable cushions should be adjusted; and
automatically adjusting the one or more of the at least two adjustable cushions to the size determined for each of the one or more of the at least two adjustable cushions.

30. The system of claim 29, wherein the detecting an event indicating that one or more of the at least two adjustable cushions should be adjusted in size comprises:
detecting that a current user of the HMD has completed use of the HMD.

31. The system of claim 29, wherein the detecting an event indicating that one or more of the at least two adjustable cushions should be adjusted in size comprises:
detecting a next user of the HMD.

32. The system of claim 29, wherein the determining a size to which each of the one or more of the at least two adjustable cushions should be adjusted comprises:
determining the size to which each of the one or more of the at least two adjustable cushions should be adjusted based on one or more of user input data, user profile data, biometrics data, preset size configurations, or default size options.
